(19) United States
(12) Patent Application Publication
(10) Pub. No.: US 2008/0024499 A1
(43) Pub. Date: Jan. 31, 2008

(54) Method and apparatus of manipulating parameterized surfaces

(76) Inventor: Christopher Bateman, Elbert, CO (US)

Correspondence Address: Christopher Bateman, 18125 Elbert Road, Elbert, CO, 80106, US

(21) Appl. No.: 11/460,249

(22) Filed: Jul. 27, 2006

(51) Int. Cl. G06T 11/20

(52) U.S. Cl. 345/441

(57) ABSTRACT

Parametric surfaces such as Attribute Based Modeling surfaces require methods of manipulating the interior of the surface. This invention provides several methods of manipulating these surfaces in a computationally efficient way. Particular attention is paid to surface continuity and discontinuity from G⁻¹ to G². Designers want to trim and join surfaces in an intuitive way; this invention provides such a method.

### FIELD OF THE INVENTION

The invention relates generally to the art of modeling surfaces and shapes of objects, and more particularly to computer implemented methods for designing shapes and representing shapes using parametric surfaces such as Attribute Based Modeling as defined in U.S. patent application Ser. No. 10/939,442. The invention provides:

1. A method of ensuring surface continuity between adjacent surfaces,

2. A method of allowing discontinuity between or within surfaces,

3. A method of trimming and joining surfaces.

The invention can be applied to industries such as, but not limited to, internet advertising, animation, automotive, aerospace, CAD/CAM, product design, geophysical exploration, and computer games.

### BACKGROUND OF THE INVENTION

In prior art, object shape is usually described or modified with a set of points or curves in space. Hoschek, Joseph and D. Lasser, Fundamentals of Computer Aided Geometric Design (1993) summarize many of these methods. In U.S. patent application Ser. No. 10/939,442 a new method is described which improves the design and modeling of shapes over the traditional methods by simplifying calculations by using a parameter space separated from the surface. This invention improves on the method described in U.S. patent application Ser. No. 10/939,442 and any other method using similar parametric surfaces by describing methods to manipulate the shape of the surface using certain derivative controls.

Fair surfaces require high-order continuity between patches and across vertices of patches. At the same time, certain disciplines, such as geophysical, require precise discontinuity in surfaces. These features should ideally be analytical rather than approximation.

Input of slopes and feature curvatures are critical operations for designers to tune the look and feel of a surface, and to reduce the total number of patches used to define an object. If the designer can “grab” the interior of a patch and manipulate the surface with interior “handles” such as tangent disks and ribbons, the design patch network can be greatly reduced. Working with ever increasing numbers of patches is counter-intuitive. Designers typically think in terms of manipulating the interior of a surface rather than in making a finer mesh of patches.

### BRIEF SUMMARY OF THE INVENTION

The invention is implemented on a computer graphics system. Parametric surfaces such as Attribute Based Modeling surfaces need methods of manipulating the surface. This invention provides several methods of manipulating these surfaces in a computationally efficient way. Particular attention is paid to surface continuity and discontinuity from G⁻¹ to G². This invention also provides an intuitive method of trimming surfaces as well as a method of joining surfaces in a water-tight way.

### BRIEF DESCRIPTION OF THE DRAWINGS

FIG. 1a shows the position and loft curves for cartoon character, while 1b. shows the subsequent bird as the calculated surface.

FIG. 2a shows patches with mismatching slopes, while 2b. shows the same patches with matching slopes.

FIG. 3 shows two lofts associated with patches along a common boundary.

FIG. 4a is an object in a 2, 3, 4 and 5 sided patch configuration, while 4b. is the isophote rendering of the same.

FIG. 5 is a checkerboard reflection of the surface with 2, 3, 4 and 5-sided patches.

FIG. 6 shows how to make a G0 continuity ridge in the middle of a patch by choosing the loft (in black) based on the side of the footprint.

FIG. 7 is Pikes Peak Mountain modeled with ridgelines and slopes.

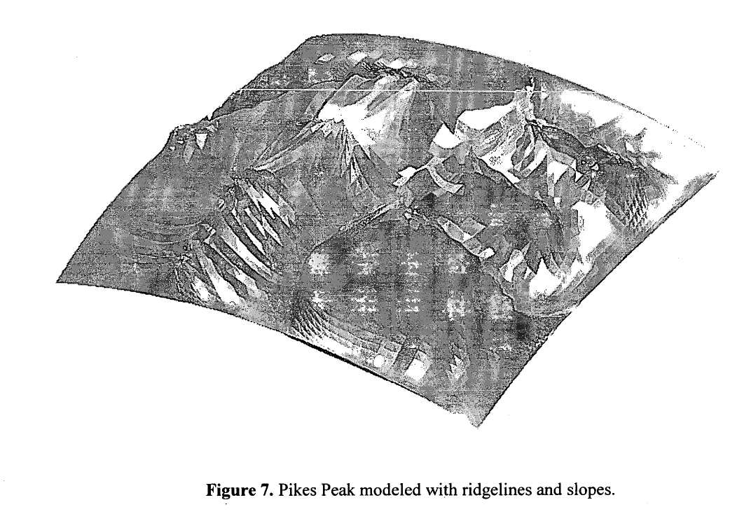

FIG. 8 is the 4 boundary curves and 7 combinations of dangling edge and slope information used to generate Pikes Peak.

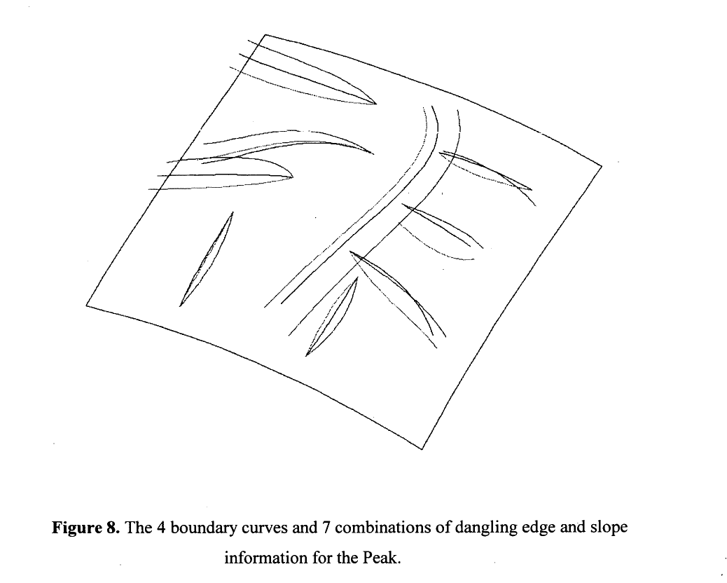

FIG. 9 shows an infinitely differentiable surface, which has a G⁻¹ discontinuity defined within the surface.

FIG. 10 demonstrates adding feature points with tangent disks of different magnitudes.

FIG. 11 specifies a tangent disk using point P, radius R and surface normal N.

FIG. 12 is a trim curve on a complex parametric surface patch.

FIG. 13 shows the left and right side of the trimmed surface of FIG. 12.

FIG. 14 Black surfaces merged perfectly to green surfaces.

FIG. 15 are two surfaces merged at a different curve.

FIG. 16 is a three-sided emblem made with trim curves and a floating curve.

### DETAILED DESCRIPTION OF THE INVENTION

In prior art, of U.S. patent application Ser. No. 10/939,442, graphical objects that are designed, manipulated or deduced by interpolating a curve, surface or hypersurface through a plurality of input features that are independently given curves, surfaces or hypersurfaces with associated derivative information, are calculated using a parameter space. This invention provides a method of manipulating parametric surfaces such as those of U.S. patent application Ser. No. 10/939,442.

One important quality of a surface is its smoothness, yet it is nontrivial to measure it quantitatively. It is common practice in the art to use derivatives to measure two functions' continuity at the join of explicit functions, however, this method does not always work for parametric functions. Sometimes two functions can form a smooth curve while their derivatives do not agree at the joint. On the other hand, there could be a sharp cusp even if the derivatives are the same. Therefore a different method must be employed.

Typically continuity—Cⁿ is used to define the smoothness in surfaces using explicit functions. The concept of geometric continuity is introduced in Hoschek, Joseph and D. Lasser, Fundamentals of Computer Aided Geometric Design (1993). However, our implementation does not impose the embedding constraints or overlapping charts. The curve may still self-intersect or approach itself infinitely close, for instance. Also see Meilson, G. Rectangular V-splines, IEEE Computer Graphics & Applications (1986) and Hermann, T, Lukacs, G and Wolter, F. Geometrical Criteria on the Higher Order Smoothness of Composite Surfaces (1999). The beauty of this characterization for Gⁿ continuity is that it works for any parameterization.

Surface Continuity—G¹

In a parametric surface such as in U.S. patent application Ser. No. 10/939,442, the attribute function fᵢ could be replaced by the first few terms of a Taylor series:

F(u)=(x,y,z)=Σᵢfᵢ(u)Wᵢ(u)/ΣᵢWᵢ(u). (1.0)

Consequently the interpolant must pass through the attributes position and also match derivatives in the series. Another extension of this method that exhibits better parameterization quality (even triangulation) is to extend the form to match tangencies to infer the partials from a lofted surface:

Rᵢ(sᵢ,tᵢ)=(1−sᵢ)fᵢ(tᵢ)+sᵢgᵢ(tᵢ), (1.1)

The parameter Si parameterizes the i^{th} loft, where sᵢ=dᵢ(u), is the distance of u to the i^{th} footprint Uᵢ. sᵢ is scaled so that sᵢ≦1. The gᵢ(t) are user given parametric curves that define the boundary of the loft. The parameter tᵢ=Pᵢ (u) is the parameter value of a projection of u onto the i^{th} footprint, and is used to parameterize the footprint in parameter space. With sᵢ and tᵢ given as functions of u, we can give the variation of Formula (1.0) that is used for G¹ as

F(u)=Σᵢ[Rᵢ(sᵢ,tᵢ))](Wᵢ(u)/ΣᵢWᵢ(u))² (1.2)

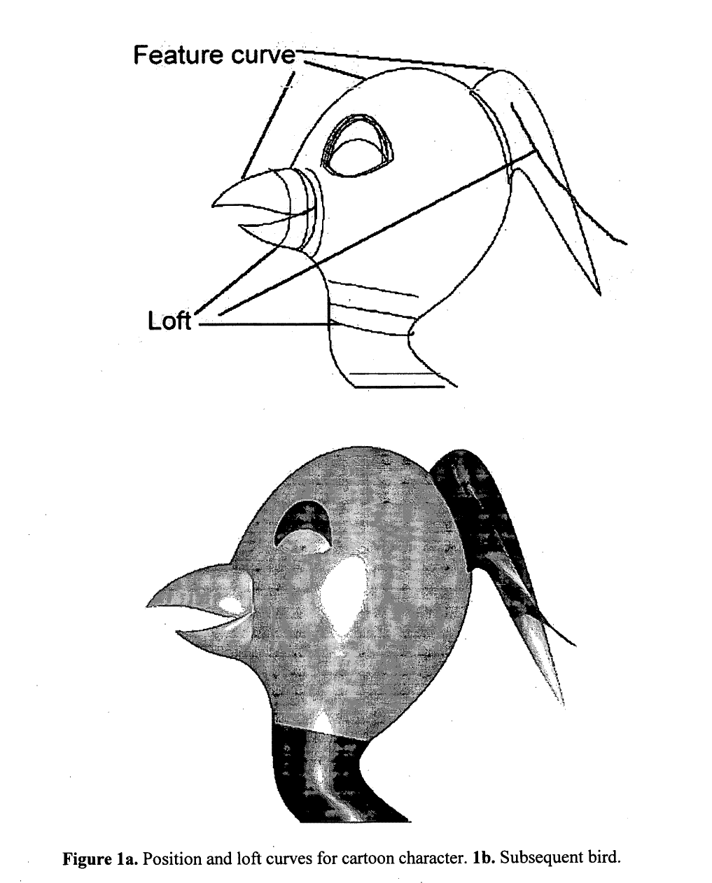

FIG. 1a shows cubic Bezier curves that serve both as position attributes fᵢ(t) darker and offset boundary curves gᵢ(t) lighter, that define the lofted surface for (1.1). FIG. 1b shows the resulting surface. The model contains two two-sided patches for the eye and eyelid, three three-sided patches for the beaks and plume and two four-sided patches for the head and neck. The number of sides on each patch matches a natural connection topology of the object being modeled.

We can re-write Formula (1.2) as:

F(u)=Σᵢ[(1−sᵢ)fᵢ(tᵢ)+sᵢgᵢ(tᵢ)]Ŵᵢ(u)² (1.3)

with Ŵᵢ(u)=(Wᵢ(u)/ΣₖWₖ(u)), where k ranges over the number of footprints.

Let us consider the partial derivatives of (1.3). For u=(u, v) and without loss of generality, let all following partials be with respect to u:

δF(u,v)=Σᵢ{[fᵢ(tᵢ)δs(u,v)+gᵢ(tᵢ)δs(u,v)]Ŵᵢ(u,v)²+[(1−sᵢ)fᵢ(tᵢ)+sᵢgᵢ(tᵢ)]2Ŵᵢ(u,v)δŴᵢ(u,v)} (1.4)

It remains to examine δŴᵢ(u,v). We write Wᵢ(u,v) in terms of the distances sᵢ=dᵢ(u,v), recalling that they are affine functions in both variables:

Wᵢ(u,v)=1/dᵢ(u,v) (1.5)

It can then be shown by induction that for 1<k<n+1 footprints that:

δWᵢ(u,v)=[2Πₖdₖ(u,v)]Pol(d₁(u,v), . . . ,dₖ(u,v),δd₁(u,v), . . . ,δdₖ(u,v))/[ΣⱼΠ_{k=1,k≠j}dₖ(u,v)²]² (1.6)

where Pol(d₁(u,v), . . . , dₖ(u,v), δd₁(u,v), . . . , δdₖ(u,v)) is a multivariate polynomial in the distances and partials. Note that Formula (1.6) always contains a multiplicative factor of dᵢ(u,v) in the numerator, while the denominator always contains an additive term without dᵢ(u,v). For example, with 4 footprints and i=1, we obtain:

2d₁d₂d₃d₄Pol(d₁, d₂, d₃, d₄, d₁′, d₂′, d₃′, d₄′)/(d₁²d₂²d₃²+d₁²d₂²d₄²+d₁²d₃²d₄²+d₂²d₃²d₄²)² (1.7)

Formula (1.6) implies that for (u₀,v₀) on the i^{th} footprint that dᵢ(u,v)=0, and for k≠i, dᵢ(u,v) is a finite, non-zero distance. Hence, the denominator is non-zero and the numerator is zero, so δŴᵢ(u₀,v₀)=0. This yields:

δF(u₀,v₀)=Σᵢ{[−fᵢ(tᵢ(u₀,v₀))+gᵢ(tᵢ(u₀,v₀))]δs(u,v)Ŵᵢ(u₀,v₀)². (1.8)

Formula (1.8) is the same form as Formula (1.7) except that the weights are squared. It is an interpolation form, which means that for any point (u₀,v₀) on the i^{th} footprint (1.8) becomes:

[gᵢ(tᵢ(u₀,v₀))−fᵢ(tᵢ(u₀,v₀))], (1.9)

which is the tangent of the loft Rᵢ(sᵢ,tᵢ)) at (u₀,v₀). That is to say that the surface is tangent to the loft at the (u₀,v₀). This is true for the partial derivatives of both u and v by symmetry. Therefore we have:

Theorem 1. Let Wᵢ(u),fᵢ(t) and gᵢ(t) be differentially continuous functions. If F(u)=ΣᵢRᵢ(s,t)(Wᵢ(u)/Σᵢ Wᵢ(u))² are defined with separate footprints, where Rᵢ(s,t)=(1−s) fᵢ(t)+s gᵢ(t), then,

δF(u₀,v₀)/δu=δRᵢ(0,t₀)/δu and δF(u₀,v₀)/δv=δRᵢ(0,t₀)/δv (1.10)

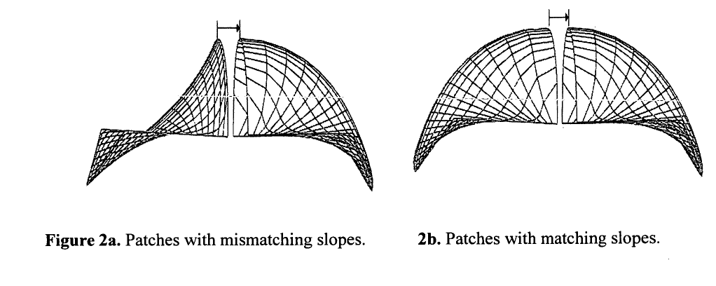

for any point (u₀, v₀) on the footprint and any t₀=P(u₀, v₀), which is an affine of u and v. Theorem 1 guarantees that if two patches with the form of Formula (1.0) share a common curve fᵢ(t) and have two lofts that share tangent planes at the common curve, the surface patches also share common tangent planes; they are G¹ at fᵢ(t). FIG. 2a shows two five-sided patches: the patch on the right is simply the patch on the left blended with a horizontally displace lofted surface. FIG. 2b shows two patches with the same cross-derivatives at the semicircular boundaries.

Surface Continuity—G²

The method of providing G² continuity is very similar in form to that of G¹ continuity, except that power of the weights is cubic and the lofts are quadratic, for example using Bernstein blending functions:

Qᵢ(s,t)=(1−s)²fᵢ(t)+2(1−s)s gᵢ(t)+s²hᵢ(t), (1.11)

Consider two lofts as in (1.11) for each i^{th} footprint, namely QLᵢ(s,t) and QRᵢ(s,t), such that QLᵢ(0,t)=QRᵢ(0,t)=fᵢ(t). This yields two surfaces L and R defined from Formula (1.0) where:

L(u)=ΣᵢQLᵢ(s,t)[Wᵢ(u)ΣᵢWᵢ(u)]³, (1.12)

and

R(u)=ΣᵢQRᵢ(s,t)[Wᵢ(u)/ΣᵢWᵢ(u)]³. (1.13)

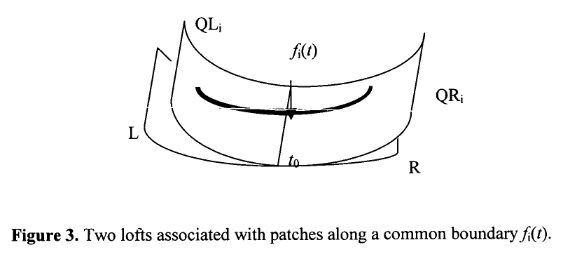

Assume that the lofts are designed so that the curves QLᵢ(s, t₀) and QRᵢ(s, t₀) for any fixed value of t₀ are G² continuous at s=0, i.e. they share the same curvature at s=0. See FIG. 3.

Let us consider all values of u that project t₀ the same to on the i^{th} footprint for L(u), that is, the line of points perpendicular to the footprint at t₀.

As in Formula (1.2), but using Formula (1.11) we get:

L′(s,t₀)=Σᵢ[QLᵢ(s,t₀)3Ŵᵢ(s)²Ŵᵢ′(s)+(−2(1−s)fᵢ(t₀)+(2−4s)gᵢ(t₀)+2shᵢ(t₀) )δs(u,v)Ŵᵢ(s)³] (1.14)

For s=0

L′(0,t₀)=Σᵢ[QLᵢ(0,t₀)3Ŵᵢ(0)²Ŵᵢ′(0)+(−2fᵢ(t₀)+2gᵢ(t₀))δs(u,v)Ŵᵢ(0)³] (1.15)

By the same steps as in the G¹ case for Formula (1.6) above we obtain:

L′(0,t₀)=Σᵢ[(2gᵢ(t₀)−2fᵢ(t₀))Ŵ₁(0)³] (1.16)

which is tangent to QLᵢ′(s, t₀). Likewise R′(s) is parallel to QRᵢ′(s, t₀) as s→0. Hence, if QLᵢ′(s, t₀) is cotangent to QRᵢ′(s, t₀), then R′(s, t₀) is cotangent to L′(s, t₀) when s=0. G¹ continuity is assured in the quadratic case for the curve at t₀. Consider now the derivative of (1.14):

$${L}^{″} ( s , {t}_{0} ) = {Σ}_{i} \{ ( 2 {f}_{i} ( {t}_{0} ) - 4 {g}_{i} ( {t}_{0} ) + 2 {h}_{i} ( {t}_{0} ) ) {{\hat{W}}_{i} ( s )}^{3} + ( {( 1 - s )}^{2} {f}_{i} ( t ) + 2 ( 1 - s ) s {g}_{i} ( t ) + {s}^{2} {h}_{i} ( t ) ) [ 6 {\hat{W}}_{i} ( s ) {\hat{W}}_{i}^{′} ( s ) + {\hat{W}}_{i}^{″} ( s ) ] + ( 2 {f}_{i} ( {t}_{0} ) - 4 {g}_{i} ( {t}_{0} ) + 2 {h}_{i} ( {t}_{0} ) ) \partial s ( u , v ) {{\hat{W}}_{i} ( s )}^{3} + ( - 2 ( 1 - s ) {f}_{i} ( {t}_{0} ) + ( 2 - 4 s ) {g}_{i} ( {t}_{0} ) + 2 s {h}_{i} ( {t}_{0} ) ) \partial s ( u , v ) 3 {{\hat{W}}_{i} ( s )}^{2} {\hat{W}}_{i}^{′} ( s ) \} . \qquad ( 1.17 )$$

### In this case, for s=0

L″(0,t₀)=Σᵢ{(2fᵢ(t₀)−4gᵢ(t₀)+2hᵢ(t₀))3Ŵᵢ′(0)²Ŵᵢ′(0)+(2fᵢ(t₀)−4gᵢ(t₀)+2hᵢ(t₀))δs(u,v)Ŵᵢ(0)³}. (1.18)

From Formula (1.6)

L″(0,t₀)=Σᵢ{(2fᵢ(t₀)−4gᵢ(t₀)+2hᵢ(t₀))δs(u,v)Ŵᵢ(0)³}. (1.19)

Once again we see the familiar blended form of Formula (1.0), in this case blending second order differences. A similar form exists for R″(0, t₀). If L(s, t₀) and R(s, t₀) are designed to have equal derivatives up to second order, then Formula (1.12) and Formula (1.13) will meet with curvature continuity, i.e. together they will form a G² curve at t₀.

The above theorem together with the continuity of the R″(s, t₀) and Q″(s, t₀) guarantees that the surfaces L and R meet with G² across the common boundary curve. We have:

Theorem 2. Let Wᵢ(u), fᵢ(t), hᵢ(t) and gᵢ(t) be differentially continuous functions. Given two surfaces L(u)=ΣᵢQLᵢ(s,t) [Wᵢ(u)/ΣᵢWᵢ(u)]³, and R(u)=ΣᵢQRᵢ(s,t) [Wᵢ(u)/ΣᵢWᵢ(u)]³, in which QLᵢ(s,t) and QRᵢ(s,t) meet with G² continuity on the boundary curves of L(u) and R(u), then L(u) and R(u) are G² continuous.

Finally, to consider the twist continuity, let us derive the mixed partials of Formula (1.0). For definition of twist continuity, please refer to Farin, G. Curves and Sufaces for CAGC, A Practical Guide (2002). Firstly,

δL(s,t)/δs=Σᵢ[QLᵢ(s,t)3Ŵᵢ(s)²δŴᵢ(s)/δs+(−2(1−s)fᵢ(t₀)+(2−4s)gᵢ(t₀)+2s hᵢ(t₀))Ŵᵢ(s)³], (1.20)

As before at s=0 it leads to

δL(0,t)/δs=(−2fᵢ(t)+2gᵢ(t))Ŵᵢ(s)³], (1.21)

then:

δL(0,t)/δsδt=(−2fᵢ′(t)+2gᵢ′(t))Ŵᵢ(s)³. (1.22)

The “twist” vector of the left surface is the blend of the twist vector of the loft. Matching twists between left and right lofts results in matching twists on the boundary of the surfaces. We have:

Theorem 3. Let Wᵢ(u),fᵢ(t), hᵢ(t) and gᵢ(t) be differentiably continuous functions. Given two surfaces L(u)=ΣᵢQLᵢ(s,t)[Wᵢ(u)/ΣᵢWᵢ(u)]³, and R(u)=ΥᵢQRᵢ(s,t) [Wᵢ(u)/ΣᵢWᵢ(u)]³, in which QLᵢ(s,t) and QRᵢ(s,t) meet with twist continuity on the boundary curves of L(u) and R(u), then L(u) and R(u) are twist continuous.

The three preceding theorems are critical to the smooth continuity between patches. One subtle, but important detail in applying the theorems is in matching the t-values on both patches, e.g., in order to make QLᵢ(s,t) and QRᵢ(s,t) meet. This may seem trivial, since the boundary curves are required to match, but the t-value function depends also on the type of distance method chosen.

Among the surface interrogation tools, isophote and ray-tracing are standard in checking whether a surface is G² continuous. Isophotes show lines of equal brightness and are defined by:

H=C cos λ (1.23)

where C is an appropriately selected constant, and λ is the angle between the surface normal N to the surface at the point P and direction p of the incident light rays.

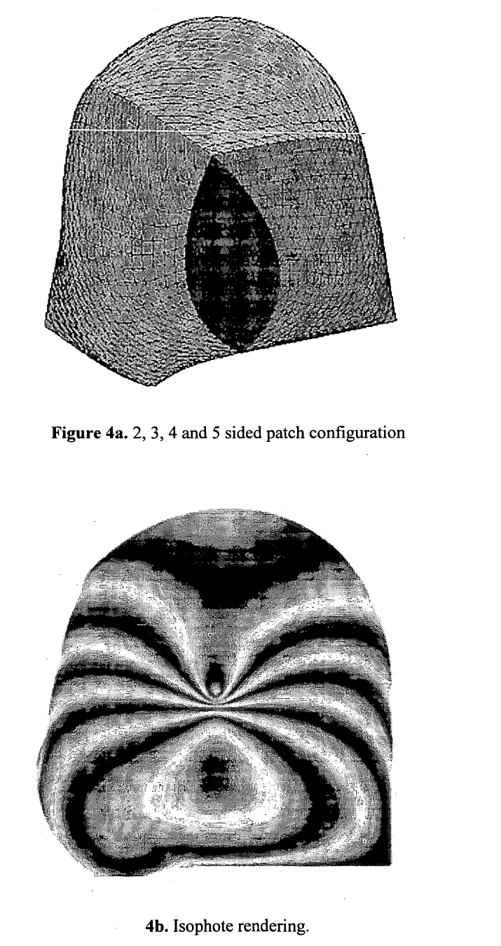

FIG. 4a shows a configuration of 2 through 5-sided patches. FIG. 4b shows the isophote rendering of the same configuration. Isophote rendering is sensitive to G² and twist continuity and would tend to kink at the boundaries where the surfaces failed to be G² or twist continuous.

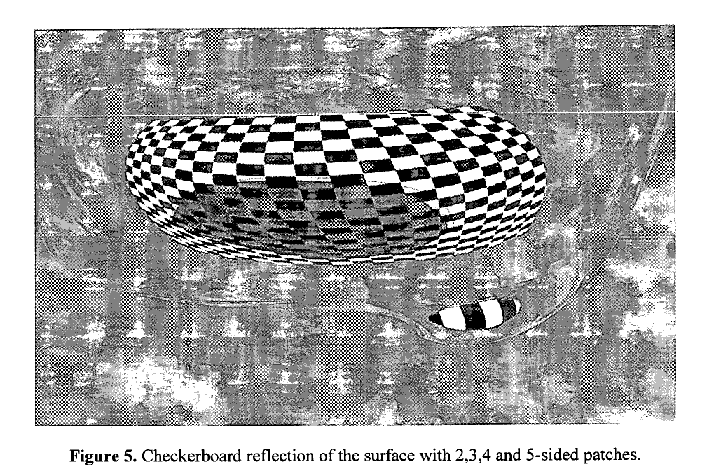

FIG. 5 shows the reflection-map ray-trace of a checkerboard reflection on the same surface as FIG. 4. It is a benchmark used in the photo studio for physical models.

Surface Discontinuity—G⁰

Much of the emphasis in surface modeling has been on achieving G¹ or G² continuity; therefore it may seem peculiar to devote attention to lower order continuity. This invention also concerns designing kinks and ridges that are not G¹ along a feature curve. In typical surface modeling systems such as in Hoschek, Joseph and D. Lasser, Fundamentals of Computer Aided Geometric Design (1993), a ridgeline can be designed only where two patches join by defining the slopes of the two patches independently of each other at the join. The technique can also be used with Attribute Based Modeling, but this approach once again imposes a topology burden on the designer; that of considering how to lay out patches to accommodate features. A designer wants to be able to define a kink in the interior of a patch. B-spline surfaces allow kinks on the surface where the knots are multiple, i.e. several knots are laid on top of each other. However, this restricts kinks to curves along equal parameter lines and forces the kink to run the length of the patch. A better approach would be to allow the user to specify a ridgeline anywhere on the surface where desired, regardless of parameter directions or patch size.

Attribute Based Modeling allows the capability to introduced floating curves in the middle of a surface. In spite of this capability, there is a problem in that the slopes of the surface leading up to the floating curves are mostly dependant on the height of the curves above the surface, i.e. is the ridges were higher then the slopes would be steeper at the ridgelines. This is suboptimal. This invention defines slopes at the ridgelines in the same way slopes can be defined by lofts at a patch boundary above, however, there needs to be two slopes, one for each side of the ridge. To address this problem this invention uses the footprint of the ridgeline to differentiate between slopes.

Let ab be the line segment for the footprint. Let fᵢ be the attribute curve that defines the ridge. Let glᵢ and grᵢ be boundary curves for defining the two-sided loft. Similar to Formula (1.1) we define the loft as:

$${R}_{i} ( {s}_{i} , {t}_{i} ) = \{ \begin{matrix} ( 1 - {s}_{i} ) {f}_{i} ( {t}_{i} ) + {s}_{i} g {l}_{i} ( {t}_{i} ) , & if 0 < θ < π \\ ( 1 - {s}_{i} ) {f}_{i} ( {t}_{i} ) + {s}_{i} g {r}_{i} ( {t}_{i} ) , & if π < θ < 2 π\end{matrix} \qquad ( 1.24 )$$

where θ=cos⁻¹ [(b−a)·(u−a)/(∥b−a∥ ∥u−a∥)].

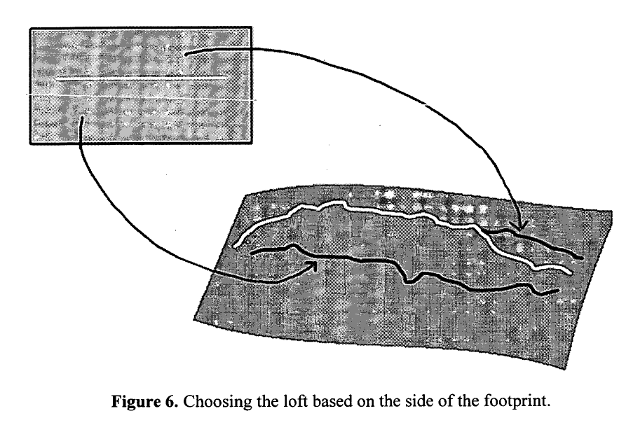

Given Formula (1.24) we now compute the surface ridge based on which side of the footprint that the parameter u is on. This is illustrated in FIG. 6. The lofts glᵢ and grᵢ are indicated in red in the figure and the ridge is black. Typically the ridgeline and the lofts would be three totally different curves, independently designable.

This invention provides G⁰ continuity possible not only across patch boundaries, but also within a patch on a floating feature curve. This is a very valuable feature for building terrain models.

The power of this is shown in FIG. 5.4, which is an attempt to model the Pikes Peak region with one patch. FIG. 5.5 shows the four boundary curves and seven internal floating curves in blue that defined the landscape. Each floating curve is associated with two boundary curves for the slope information, left in green and right in red. We implement algorithms to check whether a point lies on the lower-left or upper-right of a line in Cartesian coordinate system. Finally, noise was applied to the ridge lines. For a discussion of addition noise to feature curves see Barnsley, M. F. Fractals Everywhere (2000).

Surface Discontinuity—G⁻¹

As with G⁰ continuity, this invention can also define discontinuities in the interior of the surface, which is termed G⁻¹. Such discontinuities are previously created only at patch boundaries using Attribute-Base Modeling technologies. This invention enables the modeling of tears, or faults inside a surface. It is similar to the development of ridges in the last section.

Let ab be the line segment for the footprint. Let flᵢ and frᵢ be boundary curves for defining the two-sided function for the tear. Similar to Formula (1.1) we define the loft as

$${R}_{i} ( {s}_{i} , {t}_{i} ) = \{ \begin{matrix} f {l}_{i} ( {t}_{i} ) , & if 0 < θ < π \\ f {r}_{i} ( {t}_{i} ) , & if π < θ < 2 π\end{matrix} \qquad ( 1.25 )$$

where θ=cos⁻¹[(b−a)·(u−a)/(∥b−a∥ ∥u−a∥)].

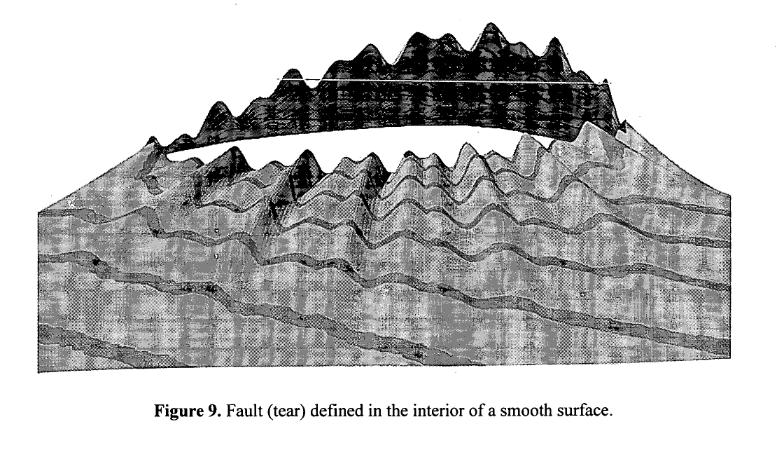

FIG. 9 shows an infinitely differentiable surface, which has a discontinuity defined as in (1.25). This feature is very useful for modeling faults in geological models.

Tangent Slopes

Discussed above was the mathematics necessary for using derivative information to design G⁰ and G⁻¹ surfaces, as well as G¹ and G² joints between patches. In fact, this theory underpins important operations in geometric modeling: input and manipulation of slopes and interior feature curvatures. This invention facilitates a designer's desire to tune the look and feel of a surface, and to reduce the total number of patches used to define an object.

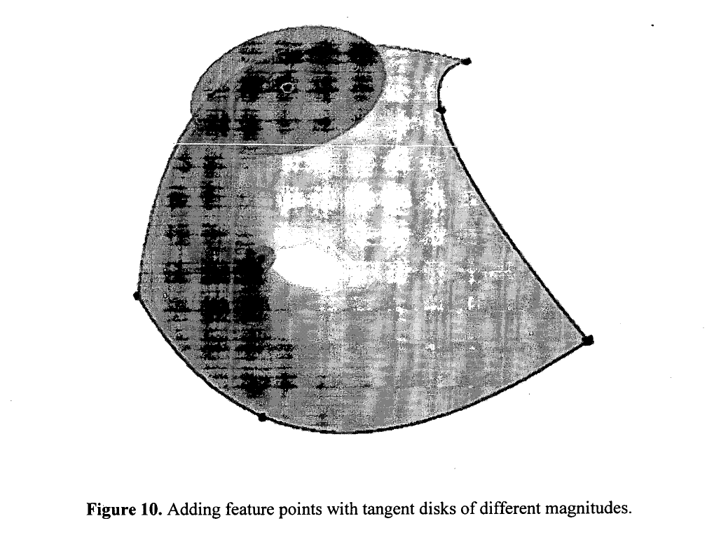

FIG. 10 demonstrates how different slopes associated with a point attribute affect the shape of a three-sided patch. The tangent disk is simply a loft for a point as given in Formula (1.3), where fᵢ(t) is a feature point rather than curve and gᵢ(t) is a given as a circle in space centered about the point. The difference between the bumps in FIG. 10 is determined by the magnitude of the tangent disk. Changing the radius of the circle changes the magnitude of the disk and that changes the subsequent sharpness of the surface about the point.

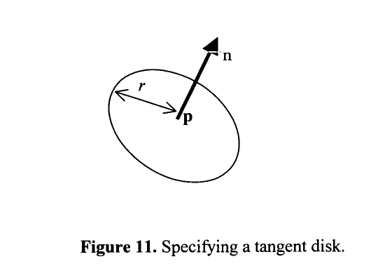

Giving a point p on a parametric surface such an Attribute-Based Modeling surface, a radius r and a surface normal n as in FIG. 11, the input of the tangent disk can be specified.

The equation of the circle, gᵢ(t), is determined by rotating the circle of radius r (r cos (t), r sin (t), 0) by the angle between the normal n and the z-axis, and then translating that by the vector p. There is no reason why the tangent disk need be circular. The tangent disk could be an ellipse or other shape as required by the designer.

Trimming Surfaces

Trimming is an important operation that can be performed on any parametrically defined surface. Let S(u.v) be a parametric surface and let C(t) be a parametric curve in parameter space of S, that is, C(t)=(Cᵤ(t), Cᵥ(t)); it has u and v components. The trim curve is then

S(Cᵤ(t),Cᵥ(t)). (1.26)

such that it is a curve on the surface. Trim curves (trimprints) are used to “stencil” or “tattoo” surfaces with curves. They are also used to cut out portions of the surface such as a wheel well or window in a car model. The latter requires that the curve in parameter space partition space into two parts, one which is drawn and the other which is derived.

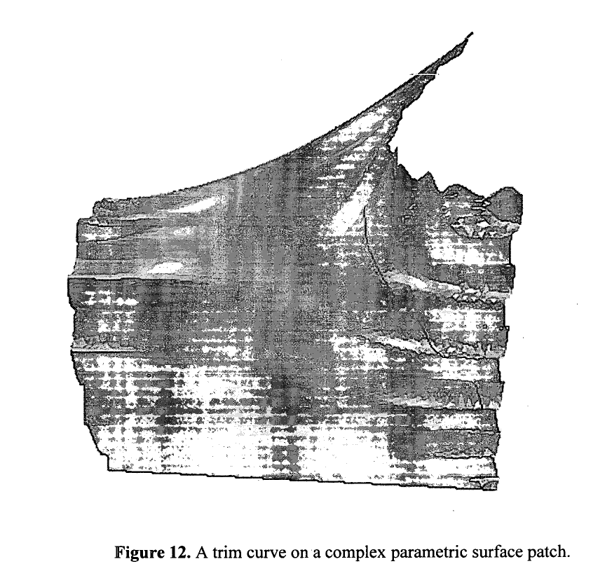

Given parametric surface such as an Attribute Based Modeling surface generated from a set of attribute curves, we can analytically “write” the curve on the surface corresponding to some “trimprint” Uᵢ in parameter space by simply replacing S in Formula (1.26) with the with the attribute curve. Using this curve as the new boundary curve, the original A-B Modeling surface has a trim curve in blue in FIG. 12. The surface is a complex five-sided patch with G¹ loft surfaces and noise on three of the sides in order to demonstrate a complex trim curve.

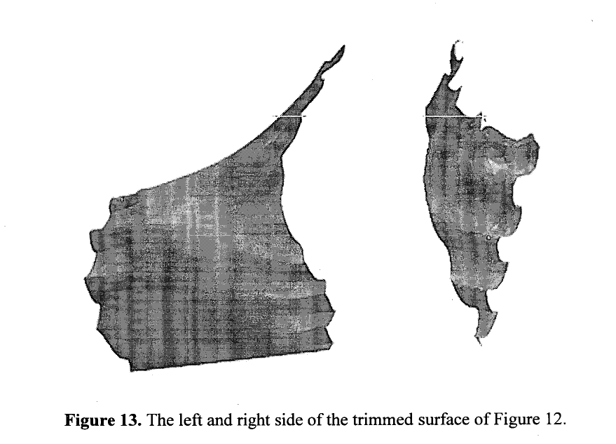

The patch in FIG. 12 is divided into two sub-patches along the trim curve in FIG. 13. The trim is accomplished by simply rendering the polygons on the appropriate side of the parameter curve.

Merging Surfaces

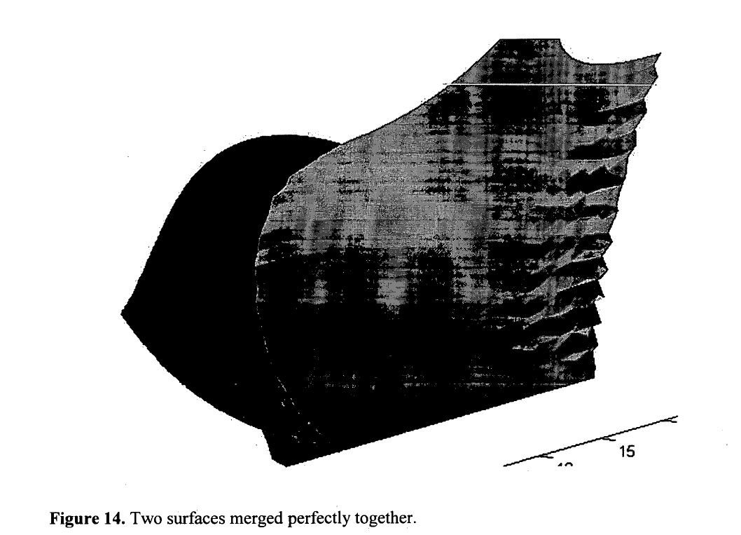

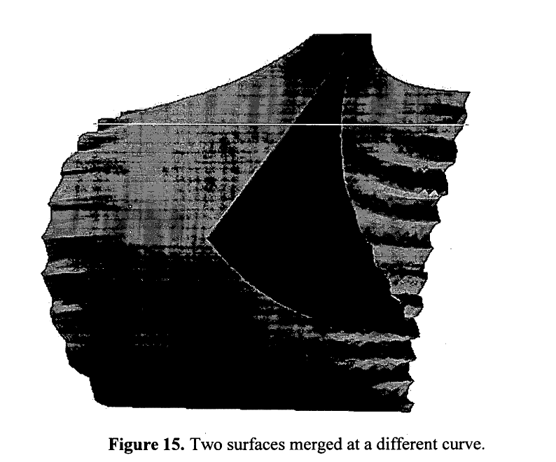

Building on the method of trimming a surface by using a trim curve in parameter space, here we examine merging two surfaces using the trim curve as a basis for one of the surfaces. One unique characteristic of our method for merging parametric surfaces is that the resulting surface has a perfect match along the seem; an analytically water-tight seem. It is called a watertight intersection. In traditional modeling, a trim line on a surface, say a B-spline surface, would not be usable as a boundary curve to another B-spline surface; it is unlikely to be another B-spline, or be too high a degree to be useful. With our method, any parametric curve may be used as input to another Attribute Based Modeling surface. This includes the trim curves of Formula (1.26). FIGS. 14 and 15 show black triangular patches that merge to the five-sided green patch at trim curves in a watertight fashion.

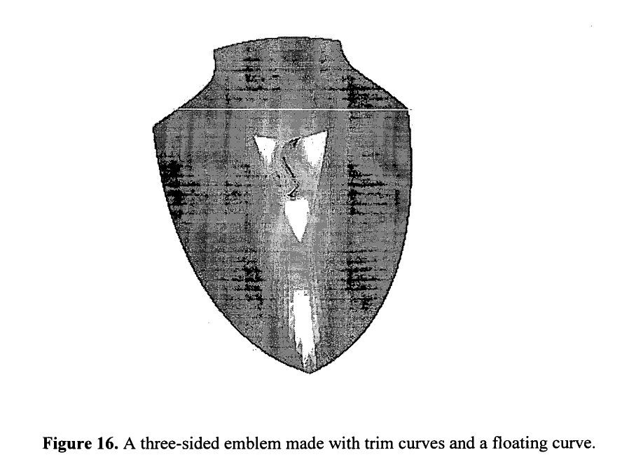

In surface modeling systems, surfaces that do not merge perfectly will show gaps and cracks with different viewing angles or zoom factors. In CAD/CAM such gaps create manufacturing problems and inside/outside test failures. FIG. 16 shows a shield that has a triangular emblem floating on the surface. All boundary curves of the emblem are trim curves of the underlying shield. The emblem is watertight to the shield. A floating curve adds extra detail.

What is claimed is:

1. A computer-implemented method for controlling the loft of a parametric surface such as an Attribute Based Modeling surface, prior art patent application Ser. No. 10/939,442 such that controls derivative to the surface are used to manipulate the surface.

2. A computer-implemented method, using first-derivative blending functions of the control loft, as in claim 1, to construct surfaces that meet at patch boundaries with G¹ continuity.

3. A computer-implemented method, using second-derivative blending functions of the control loft, as in claim 1, to construct surfaces that meet at patch boundaries with G² continuity.

4. A computer-implemented method, using two different control lofts, as in claim 1, on two sides of an interior feature curve, to achieve G⁰ discontinuity.

5. A computer-implemented method, using two different control lofts, as in claim 4, as well as two different interior feature curves, to achieve G⁻¹ discontinuity.

6. A computer-implemented method, using a lofted surface (disk or ellipse) as in claim 1, who's surface feature is a point.

7. A computer-implemented method of trimming parametric surfaces using a curve in parameter space projected onto the surface.

8. A computer-implemented method on merging parametric surfaces using the trim curve as in claim 7 as a feature curve of one of the merged surfaces.
